(19) United States
(12) Patent Application Publication
(10) Pub. No.: US 2008/0141833 A1
(43) Pub. Date: Jun. 19, 2008

(54) RATCHET WRENCH WITH ROTATABLE HEAD

(76) Inventor: Jui-Chi SHEN, Taichung Hsien (TW)

Correspondence Address: OSTROLENK FABER GERB & SOFFEN, 1180 AVENUE OF THE AMERICAS, NEW YORK, NY, 100368403, US

(21) Appl. No.: 11/611,572

(22) Filed: Dec. 15, 2006

(51) Int. Cl. B25B 13/46

(52) U.S. Cl. 81/61

(57) ABSTRACT

A ratchet wrench includes a wrench head, a handle pivotally connected to the wrench head, a retaining member having retaining and actuating ends and movable longitudinally relative to the handle to engaging and disengaging positions so as to engage and disengage the wrench head, an actuating member movable transversely relative to the handle to first and second positions so as to move the retaining member to the engaging and disengaging positions, and a biasing unit disposed to bias the actuating member toward the retaining member longitudinally so as to ensure immobility of the actuating member in the first position.

### BACKGROUND OF THE INVENTION

1. Field of the Invention

This invention relates to a ratchet wrench, more particularly to a ratchet wrench with a rotatable wrench head.

2. Description of the Related Art

Referring to FIGS. 1 and 2, a conventional ratchet wrench is shown to include a wrench head 1, a handle 2, a spring 3, and a ball 4. The wrench head 1 has a coupling end portion 101 pivotally connected to the handle 2, and a plurality of teeth 102 disposed on the coupling end portion 101. The handle 2 has an accommodation recess 201 for receiving the spring 3 and the ball 4 therein. The ball 4 is biased by the spring 3 such that when the wrench head 1 is rotated to a predetermined angular position relative to the handle 2, the ball 4 is forced to abut against the teeth 102 so as to guard against rotation of the wrench head 1. However, in use, since the ball 4 is not interferingly engaged with the teeth 102, the abutting force of the ball 4 is not sufficient, which may result in undesirable rotation of the wrench head 1.

### SUMMARY OF THE INVENTION

The object of the present invention is to provide a ratchet wrench which has a wrench head that is rotatable relative to a handle for adjusting the angular position of the wrench head, and that can be held firmly against rotation relative to the handle during use.

According to this invention, the ratchet wrench includes a wrench head having a drive portion, a first coupling portion which is disposed opposite to the drive portion in a longitudinal direction and which defines a pivot axis, and a plurality of retained segments which are disposed on the first coupling portion and which are angularly displaced from one another about the pivot axis. A handle has distal and proximate end portions opposite to each other in the longitudinal direction. The proximate end portion extends to terminate at an end wall which confronts the retained segments and which has a recess extending toward the distal end portion. The handle further has a second coupling portion which extends from the end wall away from the distal end portion and which is pivotally connected to the first coupling portion such that the retained segments are rotatable relative to the handle about the pivot axis. A retaining member is disposed in the recess, and has a retaining end that faces the retained segments, and an actuated end opposite to the retaining end. The retaining member is movable relative to the proximate end portion in the longitudinal direction between an engaging position, where the retaining end is engaged with one of the retained segments to guard against rotation of the retained segments relative to the handle, and a disengaging position, where the retaining end is disengaged from the retained segments so as to permit rotation of the retained segments. An actuating member is disposed to be moved relative to the proximate end portion in a transverse direction relative to the longitudinal direction between first and second positions, and is configured to actuate the actuated end so as to move the retaining member to the engaging and disengaging positions when the actuating member is moved to the first and second positions, respectively. A biasing unit is disposed to bias the actuating member toward the retaining member in the longitudinal direction so as to ensure immobility of the actuating member in the first position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of a conventional ratchet wrench;

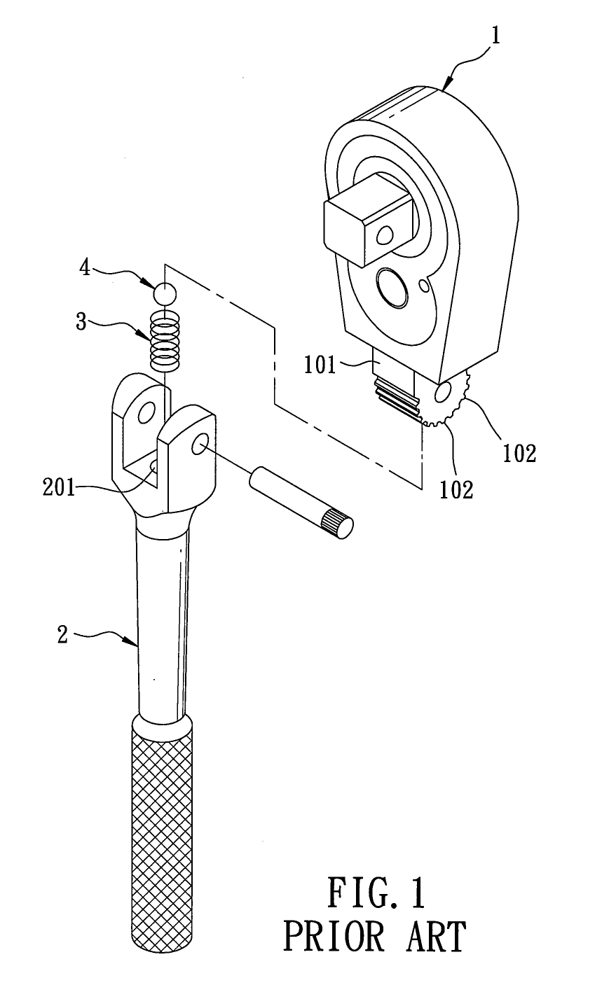

FIG. 2 is a schematic view of the conventional ratchet wrench in use;

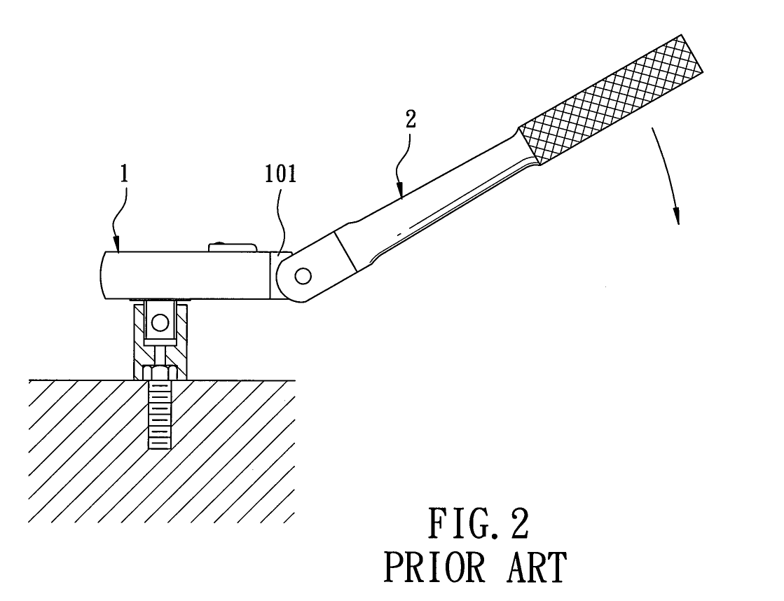

FIG. 3 is a fragmentary exploded perspective view of the preferred embodiment of a ratchet wrench according to this invention;

FIG. 4 is a fragmentary perspective view of the preferred embodiment;

FIG. 5 is a fragmentary sectional view of the preferred embodiment in a state where a retaining member is in an engaging position, an actuating member is in a first position, and a latch is in a latching position;

FIG. 6 is a fragmentary sectional view of the preferred embodiment in a state where the retaining member is in a disengaging position, the actuating member is in a second position, and the latch is in an unlatching position;

FIG. 7 is a schematic view illustrating the rotation of a wrench head relative to a handle in the state shown in FIG. 6; and

FIG. 8 is a schematic view illustrating an application of the ratchet wrench in the state shown in FIG. 5.

### DETAILED DESCRIPTION OF THE PREFERRED EMBODIMENT

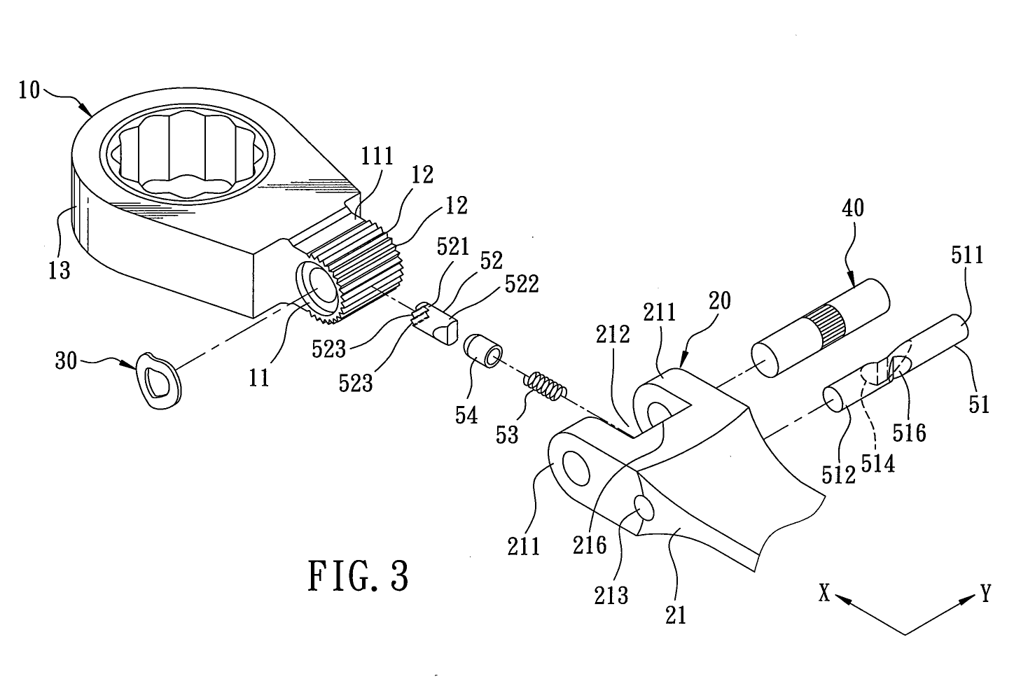

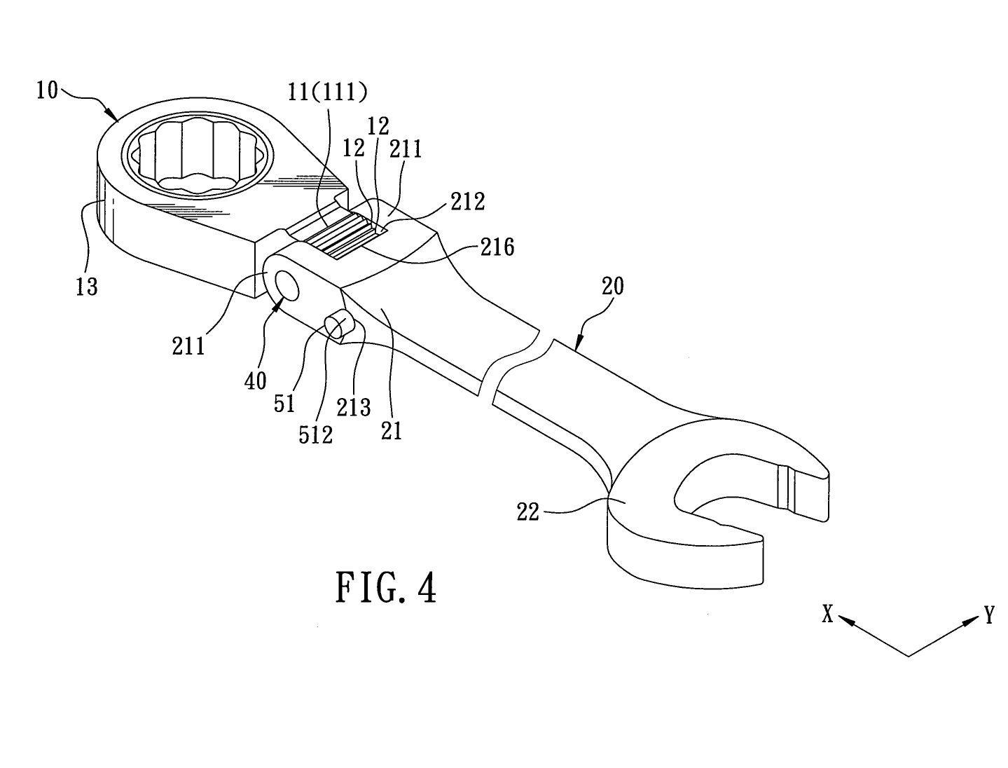

Referring to FIGS. 3 to 6, the preferred embodiment of a ratchet wrench according to the present invention is shown to comprise a wrench head 10, a handle 20, a retaining member 52, an actuating member 51, and a biasing unit including a latch 54 and a biasing spring 53.

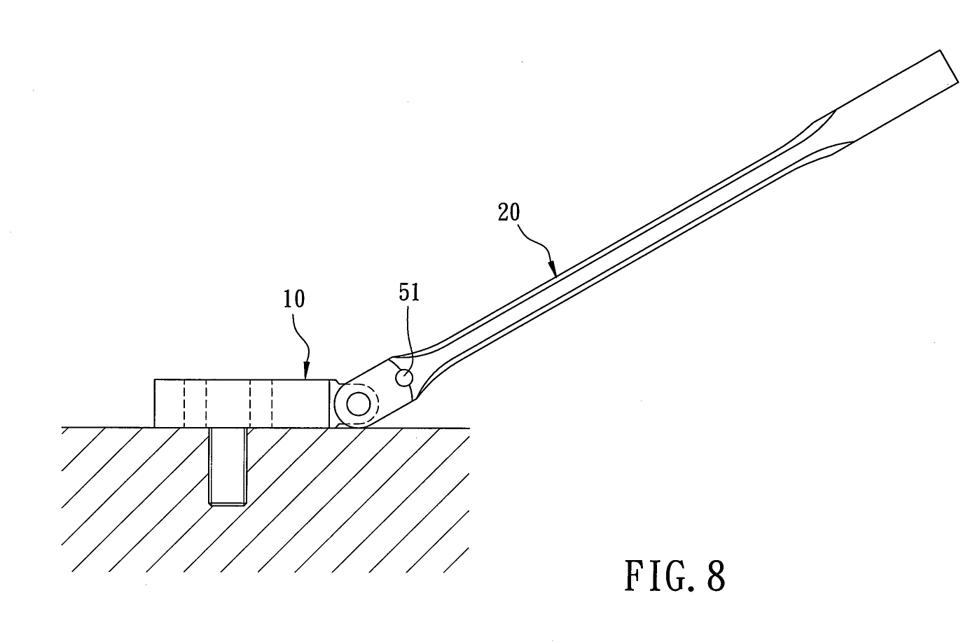

The wrench head 10 has a drive portion 13 for rotating a fastener (see FIG. 8) about a rotating axis, a first coupling portion 11 which is disposed opposite to the drive portion 13 in a longitudinal direction (X) transverse to the rotating axis, and which defines a pivot axis that is transverse to both the rotating axis and the longitudinal direction, and a plurality of retained segments 12 which are in the form of a plurality of teeth that are formed on an outer surrounding surface 111 of the first coupling portion 11 and that are angularly displaced from one another about the pivot axis. In this embodiment, the drive portion 13 is in the form of a box end of a wrench.

The handle 20 has distal and proximate end portions 22,21 opposite to each other in the longitudinal direction (X). In this embodiment, the distal end portion 22 is in the form of an open end of the wrench. The proximate end portion 21 extends to terminate at an end wall 216 which confronts the retained segments 12 in the longitudinal direction (X) and which has a recess 214 extending toward the distal end portion 22. The handle 20 further has a second coupling portion which includes two lugs 211 that extend from the end wall 216 away from the distal end portion 22 and that are spaced apart from each other in a transverse direction (Y) parallel to the pivot axis so as to define therebetween an accommodation space 212 for accommodating the first coupling portion 11 therein. A journal shaft 40 extends through the lugs 211 and the first coupling portion 11 along the pivot axis so as to permit the lugs 211 to be pivotally connected to the first coupling portion 11 about the pivot axis such that the retained segments 12 are rotatable relative to the handle 20 about the pivot axis. The proximate end portion 21 has a through bore 213 which extends therethrough in the transverse direction and which is communicated with the recess 214. Moreover, a wavy spring 30 is interposed between one of the lugs 211 and the first coupling portion 11 and is compressed to smooth pivotal movement therebetween.

The retaining member 52 is disposed in the recess 214, and has a retaining end 521 which faces the retained segments 12 and which has a plurality of teeth 523, and an actuated end 522 opposite to the retaining end 521. The retaining member 52 is movable relative to the proximate end portion 21 in the longitudinal direction (X) between an engaging position, where the teeth 523 of the retaining end 521 are in an interfering engagement with the teeth 12 to guard against rotation of the wrench head 10 relative to the handle 20 about the pivot axis, and a disengaging position, where the teeth 523 of the retaining end 521 are disengaged from the teeth 12 so as to permit rotation of the wrench head 10.

The actuating member 51 is received in the through bore 213, and has first and second operating ends 511,512 opposite to each other in the transverse direction (Y) and is operable manually. The actuating member 51 further has a cam surface 514 which engages the actuated end 522 of the retaining member 52 and which is configured to move the retaining member 52 to be close to and away from the retained segments 12 so as to place the retaining member 52 in the engaging and disengaging positions. Specifically, upon pressing the first and second operating ends 511, 512, the actuating member 51 is moved relative to the proximate end portion 21 in the transverse direction (Y) to first and second positions, where the retaining member 52 is moved to the engaging and disengaging positions, respectively, through the engagement of the cam surface 514 with the actuated end 522.

The actuating member 51 has a latch cavity 516 which is disposed opposite to the cam surface 514 in the longitudinal direction (X). The latch 54 is disposed in a receiving hole 215 formed in the proximate end portion 21 to be movable relative to the proximate end portion 21 in the longitudinal direction (X) between a latching position, where the latch 54 is engaged in the latch cavity 516 to guard against the movement of the actuating member 51, and an unlatching position, where the latch 54 is disengaged from the latch cavity 516 to permit the movement of the actuating member 51. The biasing spring 53 is disposed in the receiving hole 215 to bias the latch 54 to the latching position so as to bias the actuating member 51 toward the retaining member 52 in the longitudinal direction (X) so as to ensure immobility of the actuating member 51 in the first position.

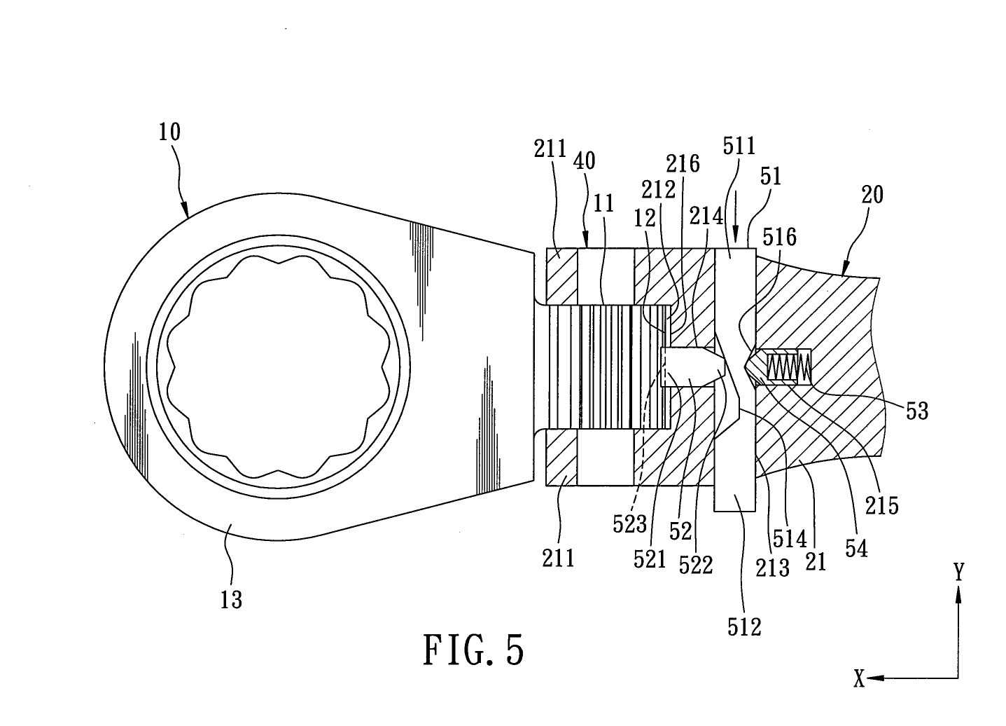

As shown in FIGS. 5 and 8, when the user presses the first operating end 511 to move the actuating member 51 to the first position, the first operating end 511 retreats into the through bore 213 while the second operating end 512 projects out of the through bore 213. Meanwhile, the retaining member 52 is moved through the cam surface 514 to the engaging position so as to guard against rotation of the wrench head 10 relative to the handle 20. In addition, the latch cavity 516 is registered with the receiving hole 215 such that the latch 54 is biased by the biasing spring 53 to the latching position to immobilize the actuating member 51. Thus, the wrench head 10 can be retained firmly at a desired angular position relative to the handle 20 for rotating a fastening piece.

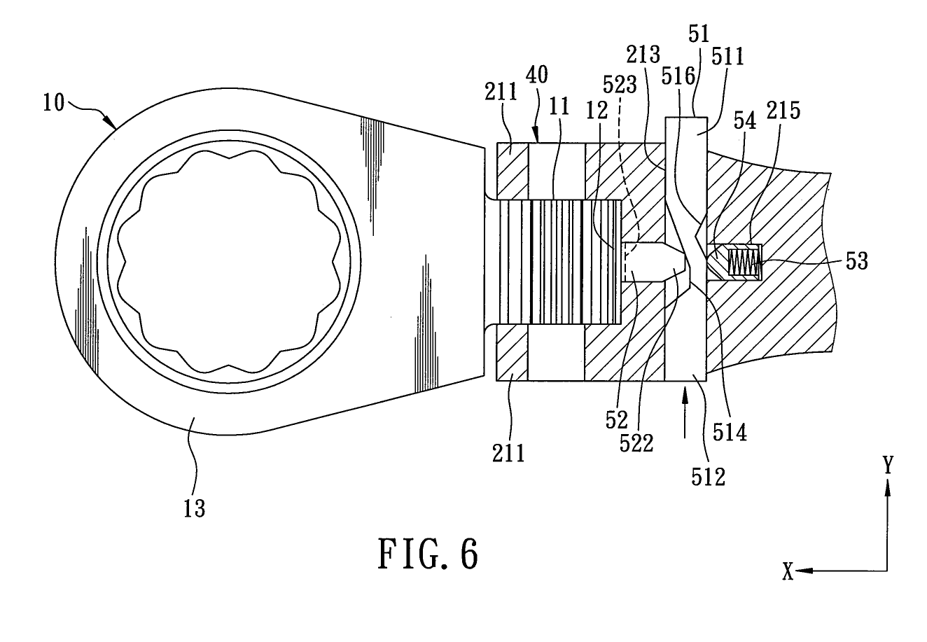

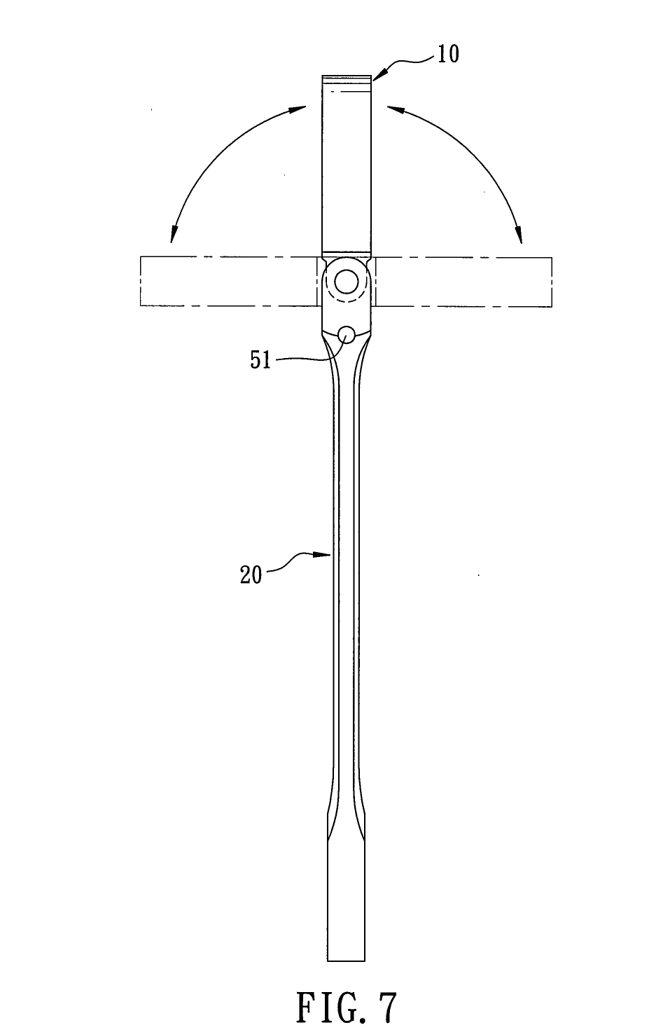

As shown in FIGS. 6 and 7, when the user presses the second operating end 512 to move the actuating member 51 to the second position, the second operating end 512 retreats into the through bore 213 while the first operating end 511 projects out of the through bore 213. Meanwhile, the latch 54 is moved into the receiving hole 215 to the unlatching position, and the retaining member 52 is moved to the disengaging position so as to permit the rotation of the wrench head 10. Thus, the user can rotate the wrench head 10 to a desired angularly position, and then press the projecting first operating end 511 so as to move the actuating member 51 to the first position for immobilizing the wrench head 10 once again.

As illustrated, the user can press either the first operating end 511 or the second operating end 512 to shift the actuating member 51 to the first or second position so as to move the retaining member 52 to the engaging or disengaging position. Thus, the operation is easy and convenient. In addition, when the retaining member 52 is in the engaging position, the latch 54 is simultaneously placed in the latching position, thereby ensuring immobility of the retained segments 12 even when the drive portion 13 is operated to rotate a fastener.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. A ratchet wrench comprising:
a wrench head having a first coupling portion, a plurality of retained segments, and a drive portion for rotating a fastening piece about a rotating axis, the first coupling portion being disposed opposite to said drive portion in a longitudinal direction transverse to the rotating axis and defining a pivot axis that is transverse to both the rotating axis and the longitudinal direction, the plurality of retained segments being disposed on said first coupling portion and being angularly displaced from one another about the pivot axis;
a handle having distal and proximate end portions opposite to each other in the longitudinal direction, said proximate end portion extending to terminate at an end wall which confronts said retained segments in the longitudinal direction and which has a recess extending toward said distal end portion, said handle further having a second coupling portion which extends from said end wall away from said distal end portion and which is pivotally connected to said first coupling portion about the pivot axis such that said retained segments are rotatable relative to said handle about the pivot axis, the proximate end portion having a through bore extending therethrough in a direction transverse to the longitudinal direction and communicating with the recess;
a retaining member disposed in said recess and having a retaining end that faces said retained segments and an actuated end opposite to said retaining end, the retaining member being movable relative to said proximate end portion in the longitudinal direction between an engaging position, where said retaining end is engaged with one of said retained segments to guard against rotation of said retained segments relative to said handle about the pivot axis, and a disengaging position, where said retaining end is disengaged from said retained segments so as to permit rotation of said retained segments about the pivot axis;
an actuating member which is received in said through bore and which has first and second operating ends located opposite to each other in the direction transverse to the longitudinal direction, the operating ends being manually operable to move said actuating member relative to said proximate end portion between a first position and a second position, the actuating member further having a cam surface and a latch cavity disposed opposite to the cam surface in the longitudinal direction, the cam surface engaging the actuated end of the retaining member to move the retaining member towards the retained segments so as to place the retaining member into the engaging position when the actuating member is moved into the first position and to move the retaining member away from the retained segments so as to place the retaining member into the disengaging position when said actuating member is moved to the second position; and
a biasing unit operable to bias said actuating member toward said retaining member in the longitudinal direction so as to ensure immobility of said actuating member in the first position, said biasing unit including a latch and a biasing spring, the latch being disposed in the proximate end portion and being movable relative to the proximate end portion in the longitudinal direction between a latching position, where the latch is engaged in the latch cavity with a static frictional force to prevent movement of the actuating member, and an unlatching position, where the latch is disengaged from the latch cavity to permit movement of the actuating member, the latch being in a non-rollable frictional engagement with the latch cavity when the latch is in the latching position, the biasing spring being operable to bias the latch to the latching position.

2. The ratchet wrench of claim 1, wherein said retaining segments are in form of teeth, and said retaining end is operable to be in an interfering engagement with said teeth when said retaining member is in the engaging position.

3. The ratchet wrench of claim 1, wherein said second coupling portion includes two lugs which are spaced apart from each other in the transverse direction to define therebetween an accommodation space such that said first coupling portion is accommodated in said accommodation space and is pivotally connected to said lugs.

4. The ratchet wrench of claim 3, further comprising a wavy spring which is interposed between one of said lugs and said first coupling portion to smooth pivotal movement therebetween.

5-7. (canceled)
